(19) United States
(12) Patent Application Publication
(10) Pub. No.: US 2008/0063594 A1
(43) Pub. Date: Mar. 13, 2008

(54) RHODIUM SULFATE PRODUCTION FOR RHODIUM PLATING

(75) Inventors: Michael J. Armstrong, Danville, CA (US); Gregory M. Omweg, Livermore, CA (US); Murali Ramasubramanian, Fremont, CA (US)

Correspondence Address: N. KENNETH BURRASTON;KIRTON & MCCONKIE, P.O. BOX 45120, SALT LAKE CITY, UT, 84145-0120, US

(73) Assignee: FormFactor, Inc.

(21) Appl. No.: 11/531,558

(22) Filed: Sep. 13, 2006

(51) Int. Cl. C01B 17/96

(52) U.S. Cl. 423/544

(57) ABSTRACT

Rhodium solutions, methods for plating structures using such rhodium solutions, and rhodium plated structures are described. The rhodium solutions can contain an increased concentration of rhodium in the form of a monomer sulfate salt. The rhodium solutions can be formed under conditions of controlled pH and controlled temperatures that increase the uniformity of the chemical composition from one rhodium solution to another. As a result, the shelf life of the rhodium solutions and plating baths using these rhodium solutions can be increased. Rhodium platings formed from these solutions can contain a low degree of dendrites, or even no dendrites. The rhodium platings can also exhibit less internal stress and can be less susceptible to cracking.

### BACKGROUND

Rhodium has been plated on substrates for many purposes. For example, rhodium has been plated onto jewelry and other decorative items because of its attractive finish. As well, because of its hardness and wear-resistance, rhodium has been plated onto the surfaces of various tools. Rhodium has also been used as a plating in the electronics industry. The invention generally relates to new rhodium solutions, methods for plating structures using such rhodium solutions, and rhodium plated structures.

### SUMMARY

Embodiments of the invention include rhodium solutions, methods for plating structures using such rhodium solutions, and rhodium plated structures. Embodiments of the rhodium solutions can contain an increased concentration of rhodium in the form of a monomer sulfate salt and can be formed under conditions of controlled pH and controlled temperatures that can increase the homogeneity of the chemical composition from one rhodium solution to another.

### BRIEF DESCRIPTION OF THE DRAWINGS

FIGS. 1A-B illustrate exemplary processes for preparing a rhodium plating solution according to some embodiments of the invention;

FIG. 2 illustrates a plating bath according to some embodiments of the invention;

FIG. 3a contains SEM photographs of a conventional rhodium plating on the left and a rhodium plating according to some embodiments of the invention on the right;

FIG. 3b illustrates a structure built up of plated rhodium according to some embodiments of the invention;

FIG. 4 illustrates a view of an electronic component and photo resist with patterned openings in which contact structures are to be formed by plating rhodium according to some embodiments of the invention;

FIGS. 5A-5C illustrate views of one process of forming an electric contact structure of plated rhodium on the electronic component of FIG. 3 according to some embodiments of the invention;

FIG. 6 illustrates a view of a sacrificial substrate and photo resist with patterned openings in which tip structures are to be formed by plating rhodium according to some embodiments of the invention;

FIGS. 7A-7C illustrate views of one process of forming tip structures of plated rhodium on the sacrificial substrate of FIG. 6 according to some embodiments of the invention;

FIG. 8 illustrates transfer of the tip structures shown in FIG. 7C to probes on a probe head according to some embodiments of the invention; and

FIG. 9 illustrates an exemplary probe card assembly according to some embodiments of the invention.

The Figures presented in conjunction with this description are views of only particular—rather than complete—portions of the devices and methods of making the devices according to some embodiments of the invention. In the Figures, the thickness of layers and regions may be exaggerated for clarity. It will also be understood that when a layer is referred to as being “on” another layer or substrate, it can be directly on the other layer or substrate, or intervening layers may also be present. The same reference numerals in different drawings represent the same element, and thus their descriptions will be omitted.

### DETAILED DESCRIPTION

Exemplary embodiments of the invention now will be described more fully with reference to the accompanying drawings. This invention may, however, be embodied in many different forms and should not be construed as being limited to the embodiments and aspects set forth herein. Although the exemplary embodiments are described with respect to rhodium-plated probe tips for testing semiconductor dies, the invention is not limited to and could be used for any other substrates or structures including jewelry, decorative items, tools, MEMS devices, LCD displays, and optoelectronic devices.

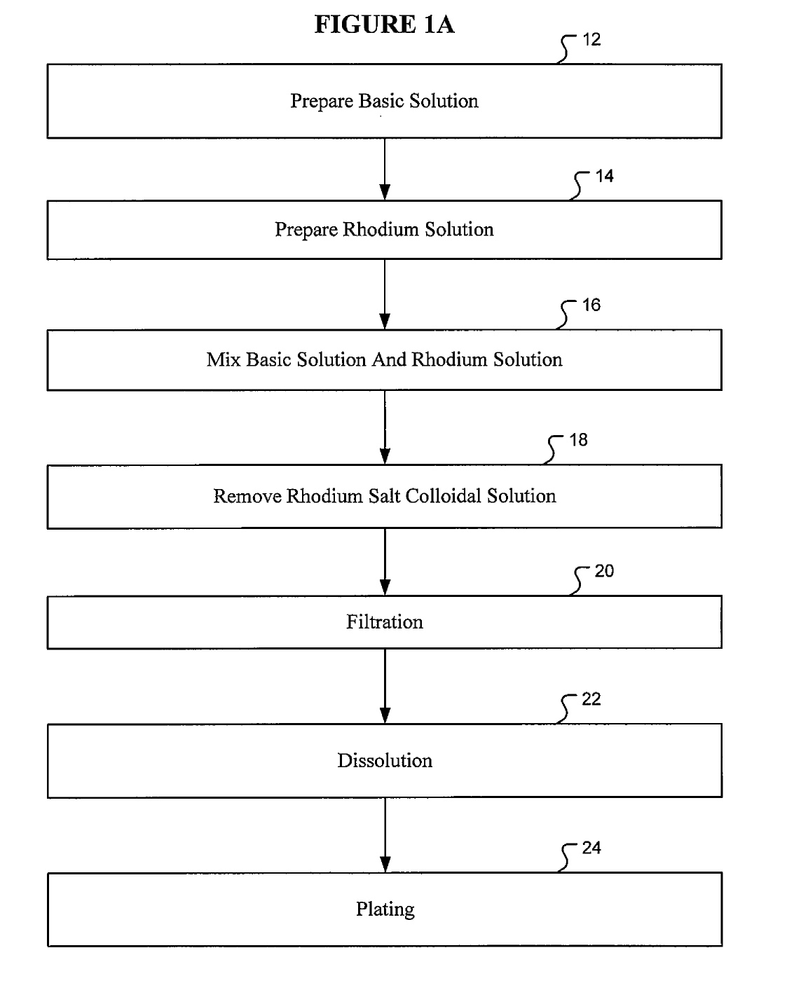

FIG. 1 illustrates an exemplary method of forming a rhodium plating solution according to some embodiments of the invention. At 12 of FIG. 1A, a basic (as opposed to acidic) solution can be formed by mixing water and a base. The basic solution can form a rhodium monomer salt when rhodium is mixed with it. Any basic solution with these characteristics can be formed at 12 of FIG. 1A. For example, the water can comprise de-ionized (DI) water. As another example, the base can comprise any alkali metal hydroxide, such as sodium or potassium hydroxide, or any alkali metal carbonate, such as sodium or potassium carbonate, or a mixture of these bases.

The concentration of the base and water in the basic solution can be adjusted to obtain the desired pH for the basic solution. For example, the concentration of the base in the basic solution can range from about 0.5N to about 3N. In the embodiments where NaOH is used as the base, the concentration can be about 120 grams/liter to provide a 12% NaOH solution.

As shown at 14 of FIG. 1A, a rhodium solution can then be prepared. The rhodium solution can be made before, after, or at the same time as the basic solution is made. The rhodium solution contains rhodium in any form, for example in some embodiments, the rhodium can be in the form of rhodium sulfate (RhSO₄). The rhodium solution can be formed my mixing the rhodium with any suitable acid. Examples of suitable acids include hydrochloric, phosphoric, nitric, and sulfuric acid (H₂SO₄).

The rhodium solution can have a pH that would not cause substantial amounts of precipitation. In some embodiments, the pH of the rhodium solution can range up to about 4. The concentration of the acid and rhodium in the solution can be adjusted to obtain the desired pH. For example, the concentration of the acid in the solution can range from about 0.001N to about 8N and the concentration of the rhodium can range from about 0.1N to about the saturation level. In the embodiments where sulfuric acid and rhodium sulfate are used, the concentration of the sulfuric acid can be about 90 to about 110 grams/liter and the concentration of rhodium sulfate can be about 9 to about 11 grams/liter. In some instances, the concentration of the sulfuric acid can be about 100 grams/liter and the concentration of rhodium sulfate can be about 10 grams/liter.

These two components, the basic solution and the rhodium solution, can then be mixed as illustrated at 16 in FIG. 1A. One example of a mixing process that can be used is illustrated in FIG. 1B. The rhodium solution is held in tank or bath 32 and the basic solution is held in tank or bath 34. Each of these solutions can be pumped through respective lines 52 and 54 into a tank or bath 36 where they are mixed.

The flow rate of both the basic solution and the rhodium solution can be controlled to provide the desired mixing conditions. In some embodiments, the flow rate of the basic solution can be controlled using a pH controller 42 that controls the pH in the tank 36. In other words, the pH controller 42 controls the flow rate of the basic solution in line 52 so that the pH within the mixing tank 36 remains within the desired range.

In some embodiments, the basic and rhodium solutions can be mixed under controlled conditions of temperature and pH. The temperature of the mixing process can be controlled to range up to about 27° C. For example, where the basic solution comprises 12% NaOH and the rhodium solution contains rhodium sulfate and sulfuric acid, the temperature can range from about 2 to about 20° C. In some instances, the temperature can be about 10° C. The pH of the mixing process can be controlled to range from about 6 to about 12.9. For example, where the basic solution comprises 12% NaOH and the rhodium solution contains rhodium sulfate and sulfuric acid, the pH can range from about 10 to about 11.

In some embodiments, the temperature and the pH can be kept substantially constant when the basic solution and the rhodium solution are mixed. Where the basic solution comprises 12% NaOH and the rhodium solution contains rhodium sulfate and sulfuric acid, the temperature can be controlled to be substantially constant within a range of about ±1° C. and the pH can be controlled to be substantially constant within a range of about ±0.5 pH. As well, in some embodiments the amount of liquid in mixing tank 36 can also be kept constant.

The reaction of the basic and rhodium solutions is an exothermic reaction. Accordingly, the mixing tank 36 can be cooled using any suitable method to keep the temperature within the desired range. In some embodiments, the tank 36 can be cooled by partially or completely enclosing the tank 36 in a cooling tank or bath 38. The cooling bath 38 can use any liquid capable of cooling the excess heat provided by the exothermic reaction, such as water chilled to a temperature ranging from about 0.2 about 20° C.

When the basic and rhodium solutions are mixed they react to form a rhodium salt, for example, rhodium hydroxide or rhodium carbonate. The type of rhodium salt formed will depend on the neutralizing base composition used in tanke 32. The rhodium salt formed in this reaction can be a colloidal rhodium salt that is suspended in the liquid present in tank 36. This colloidal rhodium salt suspension can then be removed from the tank 36, as shown at 18 in FIG. 1A. The colloidal rhodium salt suspension can be removed using any suitable process, such as by pumping the colloidal rhodium salt suspension through line 56 as depicted in FIG. 1B. In some embodiments, the colloidal rhodium salt suspension can be removed from the tank 36 at a flow rate that is substantially the same as the combined flow rate of the incoming basic solution and rhodium solution, thereby providing a continuous—rather than a batch—process for producing rhodium.

The colloidal rhodium salt suspension that has been removed can then be used to make a rhodium salt cake by any process that removes the liquid, including by filtration as shown at 20 in FIG. 1A. One example of a filtration process is illustrated in FIG. 1B. The colloidal rhodium salt suspension in line 56 is fed into a tank 40 containing a filter 46 either as a continuous or a batch process. The tank 40 can be kept at a slight vacuum of about 10 to about 500 torr by removing air 58 using a pump. By keeping the tank at a slight vacuum, the water or other liquid in the colloidal rhodium salt suspension can be drawn through the filter 46 and into the tank 40.

The result of this filtration leaves a rhodium salt cake 44 remaining in the filter 46. The rhodium salt cake can also be removed using any process, such as removal through line 62. In some embodiments, the amount of liquid and rhodium salt cake are removed from tank 40 at substantially the same rate as the colloidal rhodium salt suspension is added through line 56, thereby providing a continuous production of a rhodium salt cake.

The colloidal rhodium salt suspension—and therefore the rhodium salt cake—can contain rhodium polymers in a concentration that is substantially reduced when compared with the conventional processes. In some embodiments, the concentration of the rhodium polymer can be reduced to less than that currently determinable by nuclear magnetic resonance imaging (e.g., less than about 1%). In other embodiments, the rhodium salt suspension contains only trace amounts of rhodium polymers.

As shown at 22 of FIG. 1A, the rhodium salt cake can then be dissolved in an acid. This dissolving process can be carried out using any acid that reacts with the rhodium salt cake to form a second rhodium salt. In some embodiments, the acid used can have a low pH, i.e., a pH ranging up to about 1. Examples of acids that can be used include hydrochloric, phosphoric, nitric and sulfuric acid. Typically, sulfuric acid with a concentration ranging from about 20 to about 200 g/l can be used as the acid to dissolve the rhodium salt cake, thereby forming a rhodium sulfate solution.

The time, temperature, and pH of the dissolution of the rhodium salt cake in the acid can be controlled to reduce and/or prevent the formation of rhodium polymers. In some embodiments, the longer the time, the higher the temperature, and the higher the pH, the greater the amount of polymer that will be formed. Thus, the time, temperature, and pH can accordingly be selected so that the amount of polymer formed is minimized.

The time for the dissolution process can typically range up to about 4 hours. In some embodiments, the time can range up to about 60 minutes. Any temperature up to about 50° C. can typically be used in the dissolution process. In some embodiments, such as where sulfuric acid is used, the temperature can be less than about 10° C. And, the pH can typically be less than about 12.5. In some embodiments, the pH can be range up to about 12.

When the rhodium salt cake is dissolved in the acid, a reaction occurs between the acid and the initial rhodium salt to form a different, second rhodium salt (i.e., rhodium sulfate when sulfuric acid is used) as an aqueous solution. This second rhodium salt solution can then be filtered by any known filtration process to remove any unwanted solids. It can be helpful to perform the filtration process for any time before allowing insoluble products to persist for an extended period of time. This time period can range anywhere up to about 30 minutes to about 4 hours. The filtered solution can then be optionally stored until it is needed, or it can be used immediately.

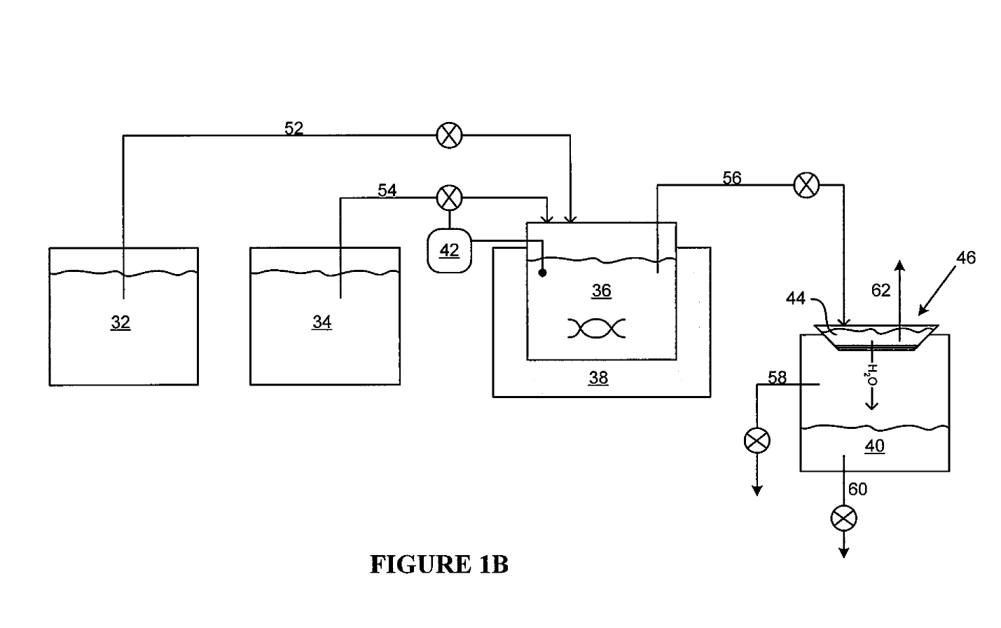

The rhodium sulfate solution can then be used in any plating process, as shown at 24 of FIG. 1A, to form a rhodium plating on any desired substrate or structure. One exemplary plating process comprises an electro-deposition process using a plating bath, such as the exemplary plating bath 100 illustrated in FIG. 2. As shown in FIG. 2, a tank 102 can hold the desired plating solution 104. An anode 106 and a cathode 108 can be immersed in the tank 102 and both can be connected to a power source 110.

The plating solution 104 can comprise rhodium sulfate that provides the rhodium ions that are then plated onto the cathode. The actual solution used in the bath can have the same concentration or a different concentration than the final rhodium solution produced by the method of FIG. 1. The concentration of the solution used in the bath can contain about 0.1 grams of rhodium per liter of solution up to the saturation level.

The plating bath solution can contain other components that help the plating process. One optional component is a conductivity enhancing component to ensure that the plating solution is electrically conductive. One example of a conductivity enhancing component is sulfuric acid.

The plating process can deposit or coat a layer of rhodium on any desired substrate. While the layer of rhodium can have any desired thickness, the plated rhodium can range up to about 30 microns. Where the rhodium layer is plated onto probes that are used to test semiconductor devices, the thickness can range from about 0.5 to about 20 microns.

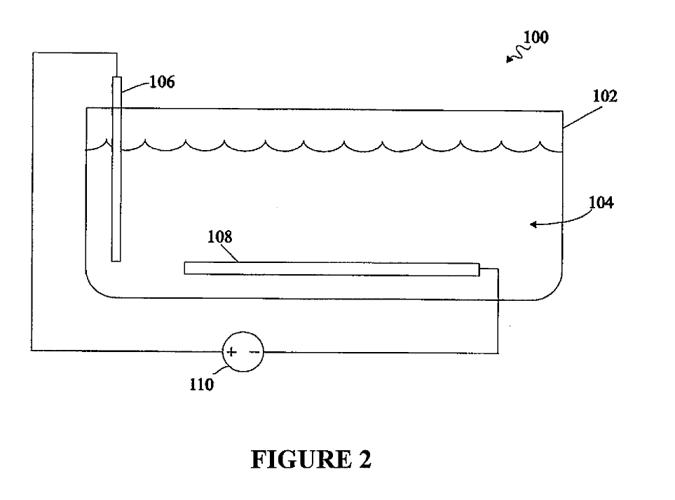

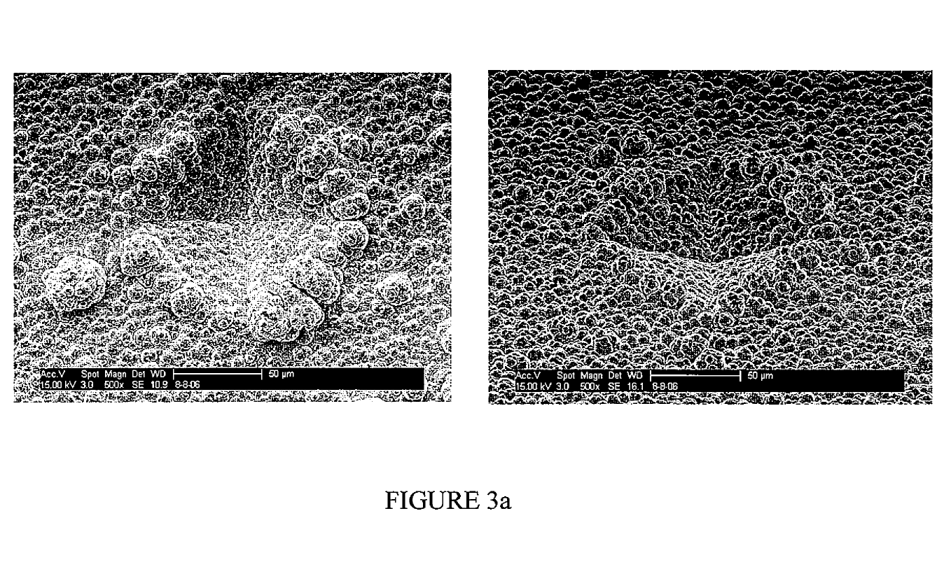

As a result of using the processes described above, the shelf life of the rhodium plating solutions and plating baths using these rhodium sulfate solutions can be increased when compared to conventional processes. As well, the rhodium platings can exhibit more contoured plating structures. For example, some of the rhodium platings formed from these solutions can contain a low degree of dendrites or nodules, and in some instances even contain substantially no dendrites or nodules. So, unlike the platings formed using conventional processes (illustrated in the left SEM photograph of FIG. 3a), the rhodium platings (illustrated in the right SEM photograph of FIG. 3a) contain structures plated with substantially no features that can be distinguished as nodules or dendrites.

The rhodium can be plated on any known substrate or structure using the plating bath solution. Although other substrates are contemplated, examples of such substrates include Si wafers, springs, sockets, molds, and electronic components such as probes for testing semiconductor devices. The rhodium can be plated on the substrate when the substrate is placed as the cathode in the plating bath 100. For example, as shown in FIG. 3b, a support structure 202 containing a conductive substrate 208 can be used as the cathode in the plating bath. A rhodium layer 212 with a thickness “t” can then be plated onto the substrate 208 using the plating bath. The support structure can be any known structure in the art, including a semiconductor wafer, a ceramic substrate, an organic substrate, a printed circuit board, etc.

The exemplary rhodium structure 212 is shown as plated on substrate 208 in FIG. 3b. But once formed on a substrate, the rhodium plating need not always remain as a plating or layer on the substrate 208. Alternatively, the rhodium layer 212 can be removed from the substrate 208 and remain as a stand alone structure. In other words, the rhodium need not be merely a layer on a preexisting structure but can be formed as a separate structure.

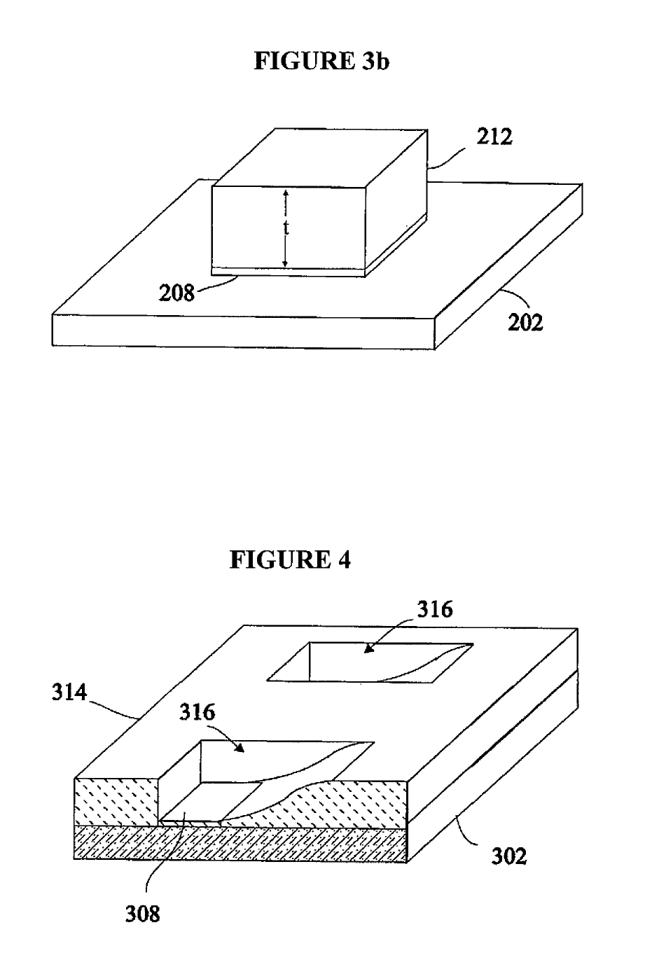

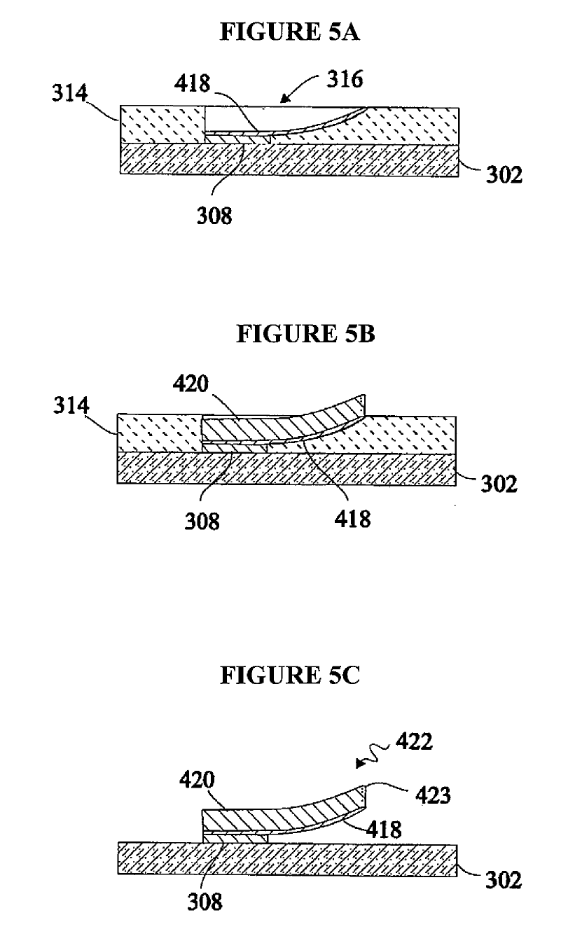

FIGS. 4 and 5A-5C illustrate one example of a rhodium plating process in which the substrate comprises the terminals of an electronic component. FIG. 4 illustrates an electronic component 302 with terminals 308 for electrical connections to other electronic components (not shown). The electronic component 302 can be any type of electronic component, including an integrated circuit (IC), a semiconductor die or wafer, a printed circuit board, a probing device, etc.

As depicted in FIG. 4, a mask layer 314 (such as a photoresist or other patternable material) can be deposited on the electronic component 302. The mask layer 314 can be patterned to define openings 316 (which can define the shape of the contact structures to be formed on the terminals) and to expose the terminals 308. While any deposition and patterning processes known in the art can be used, exemplary processes are described in U.S. patent application Ser. No. 09/364,788 and U.S. Patent Application Publication No. 2001-0044225-A1.

Next, as illustrated in FIG. 5A, a seed layer 418 can be formed in the openings 316. The seed layer 418 can be any electrically conductive material and may be deposited in any suitable manner, such as by sputtering or printing. Non-limiting examples of suitable conductive materials for the seed layer include copper, palladium, tungsten, silver, and combinations or alloys thereof.

The structure illustrates in FIG. 5A can then be placed in the plating solution 104 of FIG. 2. The seed layers 418 can be connected to the power source 110 so that the seed layers act as the cathode. Any electrical connection that connects the seed layers 418 to the power source 110 can be used in the plating bath shown in FIG. 2. One example of such an electrical connection involves depositing a conductive, blanket layer (not shown) over the electronic component 302 before applying the mask layer 314. This can electrically connect all of the terminals 308, and therefore all of the seed layers 418. An electrical connection (not shown) can then provided from the blanket layer (not shown) to the power source 110.

As shown in FIG. 5B, a rhodium layer can be plated onto the seed layer 418 for a time sufficient to form a rhodium structure 420 with the desired thickness. Then the resulting structure can be removed from the plating bath. Next, as shown in FIG. 5C, the mask layer 314 can be removed by any selective etching process, leaving rhodium contact structure 422 formed on the terminals 308 of the electronic component 302. If the blanket layer used to interconnect all of the terminals 308, the exposed areas of the blanket layer can also be removed by any selective etching process. The resulting structure contains tip portions 423 that, when brought into contact with another electronic component, electrically connects the electronic component 302 to that other electronic component (not shown).

Although not shown in FIGS. 5A-5C, one or more additional layers of materials can be formed on the rhodium structures 422. As well, one or more additional layers of materials can be formed on the seed layer 418 prior to making the rhodium structure 422. The rhodium structures 422 can also be formed “upside down” on a sacrificial substrate (i.e., with the tip portion 423 formed on the sacrificial substrate). The exposed ends of the rhodium structures 422 can then be attached to terminals of an electronic component (such as electronic component 302) and the rhodium structures 422 released from the sacrificial substrate. Examples of this process are described in U.S. Pat. No. 6,482,013.

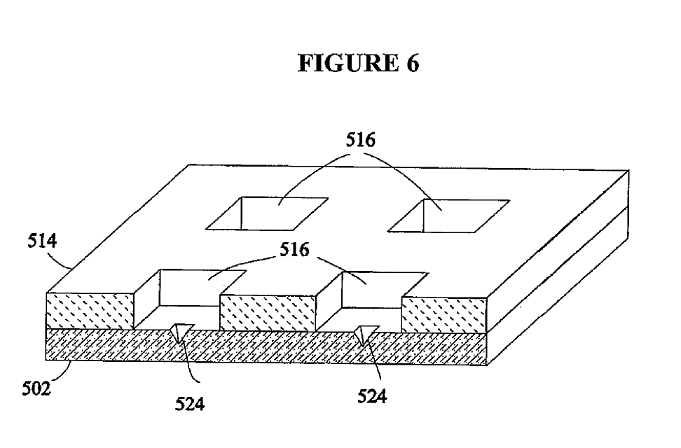

FIGS. 6, 7A-7C, and 8 illustrate another example of a process for plating rhodium. In these Figures, tip structures can be formed of plated rhodium and attached to probes of a device for probing an electronic device. FIG. 6, a sacrificial substrate 502 can be first provided. Substrate 502 may be made of any material such as, for example, a silicon wafer. Pits 524 can be formed in the upper surface of the substrate 502 by any known method, such as a conventional masking and etching process. A mask layer 514 (such as a photoresist or other patternable material) can be formed on the surface of the sacrificial substrate 502. The mask layer 514 can be patterned to form openings 516 with a shape substantially similar to the shape of the probe tips. The openings 516 can be also formed in the location of pits 524, exposing pits 524.

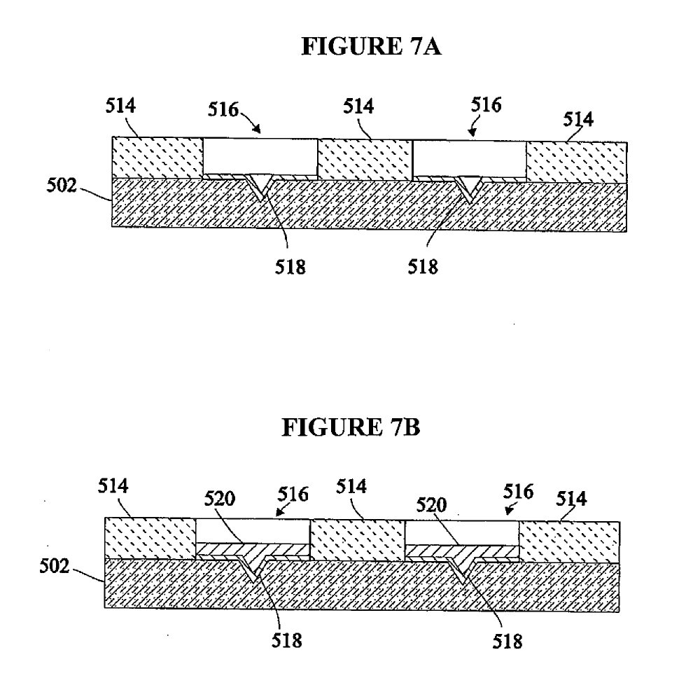

As shown in FIG. 7A, a seed layer 518 can be formed in the openings 516 and the pits 524. Like the seed layer 418, seed layer 518 can function as the cathode in the plating bath. In addition, seed layer 518 can also act as a release layer for tip structures that are formed over the seed layer. As an alternative, separate seed and release layers may be deposited one on top of the other in openings 516.

The sacrificial substrate 502 can be placed in the plating bath and the seed layer 518 connected to the power source 110 in the manner similar to that described above, allowing the seed layer 518 to act as a cathode in the plating process. Once the desired amount of rhodium 520 has been plated onto the seed layer 518, as shown in FIG. 7B, the resulting structure can be removed from the plating bath.

As shown in FIG. 7C, additional layers may optionally be formed over the rhodium layer 520. For example, as shown in FIG. 7C, a layer of nickel 526 and then a layer of gold 528 can be formed over the rhodium layer 520. The nickel 526 can enhance the structural strength of the tip structure 530 and the gold layer 528 can enhance subsequent attachment of the tip structures 530 to probe bodies 542, as described below.

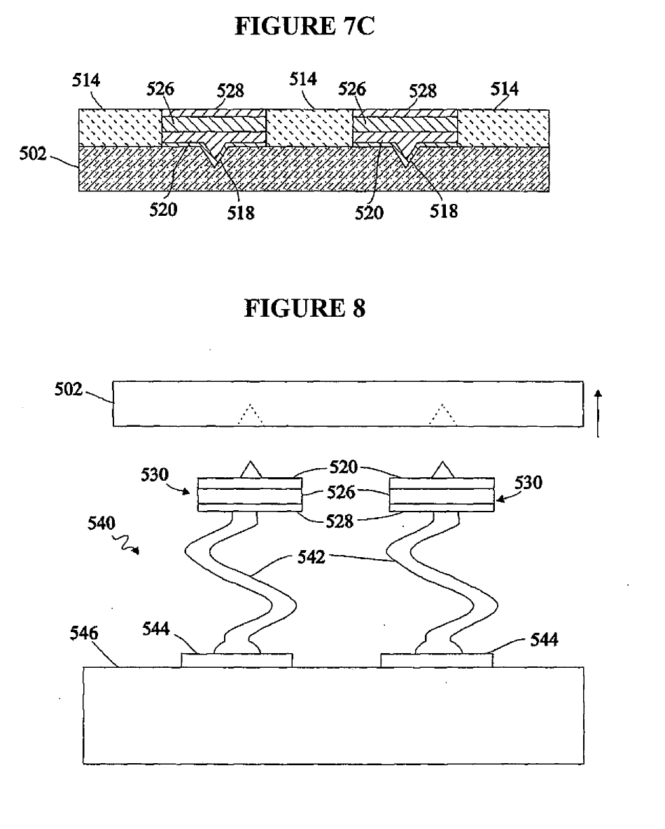

As depicted in FIG. 8, the mask layer 514 can be removed, and the tip structures 530 can be attached to probe bodies 542. The tip structures 530 can be attached to the probe bodies 542 in any suitable manner, including by soldering, brazing, or welding. The tip structures 530 can then be released from the sacrificial substrate 502 by etching or dissolving the seed layer 518.

Tip structures 530 can be formed with any shape and size. Non-limiting examples of various shapes and sizes are described in U.S. Pat. No. 6,441,315. The tip structures 520 can be made with such shape and sizes by selecting matching shape and sizes for the openings 516 and the pits 524.

In this manner, probe bodies 542 can be provided with rhodium tip structures 530 to form contact structures 540. Probe bodies 542 can be any type of probe, including needle probes, buckling beam probes, bump probes, or spring probes. Probe bodies 542 may be a resilient, conductive structure. Non-limiting examples of suitable probe bodies 542 include composite structures formed of a core wire that is over coated with a resilient material as described in U.S. Pat. No. 5,476,211, U.S. Pat. No. 5,917,707, and U.S. Pat. No. 6,336,269. Probe bodies 542 may alternatively be lithographically formed structures, such as the spring elements disclosed in U.S. Pat. No. 5,994,152, U.S. Pat. No. 6,033,935, U.S. Pat. No. 6,255,126, U.S. Patent Application Publication No. 2001/0044225, and U.S. Patent Application Publication No. 2001/0012739. Other non-limiting examples of probe bodies 542 include those disclosed in U.S. Pat. No. 6,827,584, U.S. Pat. No. 6,640,432, and U.S. Patent Publication No. 2001-0012739.

In addition, structures other than tip structures can be formed with rhodium tips. Probe beams and even entire probes can be formed and then transferred to posts or terminals on a probe head. Examples are shown in U.S. patent application Ser. No. 09/953,666 and U.S. Patent Publication No. 2001-0012739-A1.

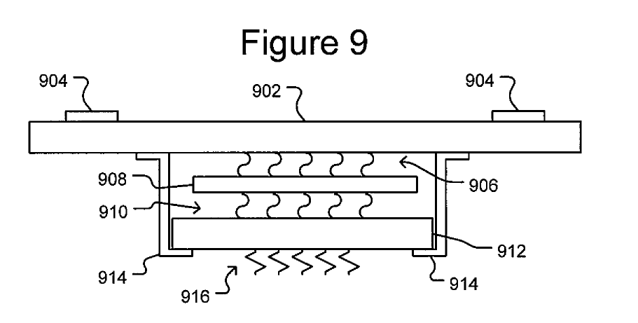

FIG. 9 illustrates on exemplary application of contact structures, like contact structures 422 or 540, according to some embodiments of the invention. FIG. 9 illustrates an exemplary probe card assembly, which can be used in testing semiconductor dies (singulated or unsingulated). As will be discussed, the probes 916 of FIG. 9 can be contact structures like contact structures 422 or 540.

As shown, the exemplary probe card assembly of FIG. 9 can include three substrates: a wiring board 902, an interposer 908, and a probe substrate 912. Terminals 904 can provide electrical connections to and from a tester (not shown). Terminals 904 can be any suitable electrical connection structure including without limitation pads for receiving pogo pins, zero-insertion-force connectors, or any other connection device suitable for making electrical connections with a tester (not shown).

Electrical connections (e.g., electrically conductive terminals, vias and/or traces) (not shown) can provide electrical connects from terminals 904 through wiring board 902 to electrically conductive spring contacts 906. Additionally, electrical connections (e.g., electrically conductive terminals, vias and/or traces) (not shown) can be provided through interposer 908 to connect spring contacts 906 to spring contacts 910, which may be like spring contacts 906. Additionally, electrical connections (e.g., electrically conductive terminals, vias and/or traces) (not shown) can electrically connect spring contacts 910 through probe substrate 912 to probes 916, which as mentioned above, can function as probes disposed to contact terminals of the electronic device or devices to be tested. Electrical connections (not shown) can thus be provided from terminals 904 through the probe card assembly to probes 916. Probe substrate 912 and interposer 908 can be secured to wiring board 902 using any suitable means, including, without limitation, bolts, screws, clamps, brackets, etc. In the example shown in FIG. 9, probe substrate 912 and interposer 908 can be secured to wiring board 902 by way of brackets 912.

The probe card assembly illustrated in FIG. 9 is exemplary only and many alternative and different configurations of a probe card assembly may be used. For example, a probe card assembly can include fewer or more substrates than the probe card assembly shown in FIG. 9. As another example, a probe card assembly can include a plurality of probe substrates 912, each having a set of probes, like probes 916, that together form a large probe array, and each of the probe substrates can be individually adjustable. Non-limiting examples of such probe card assemblies are shown in U.S patent application Ser. No. 11/165,833, filed Jun. 24, 2005. Additional non-limiting examples of probe card assemblies are illustrated in U.S. Pat. No. 5,974,622 and U.S. Pat. No. 6,509,751 and various features of the probe card assemblies described in those patents as well as the probe card assemblies disclosed in the aforementioned U.S patent application Ser. No. 11/165,833 can be implemented in the probe card assembly show in FIG. 9.

Having described exemplary embodiments of the invention, it is understood that the invention defined is not to be limited by particular details set forth in the above description, as many apparent variations thereof are possible without departing from the spirit or scope thereof.

We claim:

1. A method for making a rhodium salt cake, comprising:
providing a basic solution;
providing an acidic solution containing rhodium;
mixing the acidic and basic solutions to form a colloidal suspension containing rhodium salt; and
removing liquid from the rhodium salt suspension.

2. The method of claim 1, wherein the acidic and basic solutions are mixed at a substantially constant pH.

3. The method of claim 1, wherein the acidic and basic solutions are mixed at a substantially constant temperature.

4. The method of claim 1, wherein the concentration of the base in the basic solution ranges from about 0.5 to about 3 N.

5. The method of claim 1, wherein concentration of rhodium polymers in the rhodium salt cake is less than about 1% of all the rhodium present in the cake.

6. The method of claim 5, wherein there only are trace amount of rhodium polymers in the rhodium salt cake.

7. The method of claim 1, wherein the method operates on a continuous basis.

8. A method for making a rhodium salt cake, comprising:
providing a basic solution;
providing an acidic solution containing rhodium;
mixing the acidic and basic solutions at a substantially constant pH and a substantially constant temperature to form a colloidal suspension containing a rhodium salt; and
removing liquid from the rhodium salt suspension.

9. The method of claim 8, wherein the method operates on a continuous basis.

10. The method of claim 7, wherein concentration of rhodium polymers in the rhodium salt cake is less than about 1% of all the rhodium present in the cake.

11. The method of claim 10, wherein there exist only trace amounts of rhodium polymers in the rhodium salt cake.

12. A method for making a rhodium salt cake, comprising:
providing a basic solution;
providing an acidic solution containing rhodium;
mixing the acidic and basic solutions at a substantially constant pH and a substantially constant temperature to form a colloidal salt suspension containing rhodium polymers in a concentration of less than about 1% of the suspension; and
removing liquid from the rhodium salt suspension.

13. The method of claim 12, wherein the method is performed on a continuous basis.

14. The method of claim 12, wherein there only are trace amount of rhodium polymers in the rhodium salt cake.

15. A method for making a rhodium salt solution on a continuous basis, comprising:
providing a rhodium salt cake by:
providing a basic solution;
providing an acidic solution containing rhodium;
mixing the acidic and basic solutions to form a colloidal suspension containing a rhodium salt; and
removing liquid from the rhodium salt suspension;
mixing the rhodium salt cake with an acid.

16. The method of claim 15, wherein the acidic and basic solutions are mixed at a substantially constant pH and a substantially constant temperature.

17. The method of claim 15, wherein the concentration of rhodium polymers in the colloidal suspension is less than about 1% of all the rhodium in the suspension.

18. A method for making a rhodium plating bath, comprising:
providing a rhodium salt cake on a continuous basis by:
providing a basic solution;
providing an acidic solution containing rhodium;
mixing the acidic and basic solutions to form a colloidal suspension containing a rhodium salt; and
removing th liquid from the rhodium salt suspension;
mixing the rhodium salt cake with an acid to make a rhodium salt solution; and
placing the rhodium salt solution in a bath.

19. The method of claim 18, wherein the acidic and basic solutions are mixed at a substantially constant pH and a substantially constant temperature.

20. The method of claim 18, wherein the concentration of rhodium polymers in the colloidal suspension is less than about 1% of all the rhodium in the suspension.

21. A method for plating rhodium, comprising:
providing a plating solution by:
providing a rhodium salt cake on a continuous basis by providing a basic solution, providing an acidic solution containing rhodium, mixing the acidic and basic solutions to form a colloidal suspension containing a rhodium salt, and removing liquid from the rhodium salt suspension;
mixing the rhodium salt cake with an acid to make a rhodium salt solution; and
placing the rhodium salt solution in a bath; and
placing a substrate in the plating solution.

22. A rhodium salt cake prepared by a continuous method comprising:
providing a basic solution;
providing an acidic solution containing rhodium;
mixing the acidic and basic solutions to form a colloidal suspension containing a rhodium salt; and
removing liquid from the rhodium salt suspension.

23. A rhodium salt solution prepared by a continuous method comprising:
providing a rhodium salt cake by:
providing a basic solution;
providing an acidic solution containing rhodium;
mixing the acidic and basic solutions to form a colloidal suspension containing a rhodium salt; and
removing liquid from the rhodium salt suspension; and
mixing the rhodium cake with an acid.

24. A rhodium plating bath made by the method comprising:
providing a rhodium salt cake on a continuous basis by:
providing a basic solution;
providing an acidic solution containing rhodium;
mixing the acidic and basic solutions to form a colloidal suspension containing a rhodium salt; and
removing liquid from the rhodium salt suspension;
mixing the rhodium salt cake with an acid to make a rhodium salt solution; and
placing the rhodium salt solution in a bath.

25. Plated rhodium made by the method comprising:
providing a plating solution by:
providing a rhodium salt cake on a continuous basis by providing a basic solution, providing an acidic solution containing rhodium, mixing the acidic and basic solutions to form a colloidal suspension containing a rhodium salt, and removing liquid from the rhodium salt suspension;
mixing the rhodium salt cake with an acid to make a rhodium salt solution; and
placing the rhodium salt solution in a bath; and
placing a substrate in the plating solution.

26. A colloidal suspension containing a rhodium salt, wherein the concentration of rhodium polymers is less than about 1% of all the rhodium present in the suspension.

27. A rhodium salt cake, wherein the concentration of rhodium polymers is less than about 1% of all the rhodium present in the cake.

28. A rhodium sulfate solution, wherein the concentration of rhodium sulfate polymers is less than about 1% of all the rhodium sulfate present in the solution.

29. A method for testing semiconductor dies, the method comprising:
providing a plating solution by:
providing a rhodium salt cake on a continuous basis by providing a basic solution, providing an acidic solution containing rhodium, mixing the acidic and basic solutions to form a colloidal suspension containing a rhodium salt, and removing liquid from the rhodium salt suspension;
mixing the rhodium salt cake with an acid to make a rhodium salt solution; and
placing the rhodium salt solution in a bath; and
placing a tip of an electrical probe in the plating solution; and
pressing the tip to a bond pad of a semiconductor die.

30. A probe tip made by the method comprising:
providing a plating solution by:
providing a rhodium salt cake on a continuous basis by providing a basic solution, providing an acidic solution containing rhodium, mixing the acidic and basic solutions to form a colloidal suspension containing a rhodium salt, and removing liquid from the rhodium salt suspension;
mixing the rhodium salt cake with an acid to make a rhodium salt solution; and
placing the rhodium salt solution in a bath; and
placing a tip of an electrical probe in the plating solution.
